(19) United States
(12) Patent Application Publication
(10) Pub. No.: US 2022/0171896 A1
(43) Pub. Date: Jun. 2, 2022

(54) METHOD FOR DESIGN OF VEHICLE BODY COMPONENT

(71) Applicants: Darshan S. Pawargi, Pune (IN); Vikas V. Joshi, Pune (IN); Sanket M. Bodh, Pune (IN)

(72) Inventors: Darshan S. Pawargi, Pune (IN); Vikas V. Joshi, Pune (IN); Sanket M. Bodh, Pune (IN)

(21) Appl. No.: 17/109,408

(22) Filed: Dec. 2, 2020

(51) Int. Cl. G06F 30/15

(52) U.S. Cl. CPC G06F 30/15; G06F 2111/10

(57) ABSTRACT

A method of evaluating a vehicle body component design. The method includes: calculating one or more head injury criteria (HIC) ground values for one or more points of interest of a base body component design of a base vehicle; generating an HIC predictive model based on the one or more HIC ground values; obtaining one or more parameter values of one or more points of interest of a candidate body component design, the point(s) of interest of the candidate body component design corresponding to the point(s) of interest of the base body component design of the base vehicle; calculating one or more predicted HIC values for the candidate body component design, wherein the calculation of the predicted HIC value(s) includes inputting the parameter value(s) into the HIC predictive model to obtain the predicted HIC value(s); and evaluating the candidate body component design by inspecting the predicted HIC value(s).

### FIELD

The present disclosure relates to methods for design of vehicle body components in view of impact prediction criteria.

### BACKGROUND

Passenger vehicles are designed to reduce the impact on both the passengers of the vehicle and pedestrians that may be contacted by the vehicle body during an accident. In particular, vehicle body components, such as a hood or bonnet (both are referred to as a “hood”), are designed and configured to minimize the impact felt by a pedestrian when struck by the vehicle. Various metrics or measures may be used for evaluating a vehicle's capability for reducing such impacts.

One such measure is called “head injury criterion” or “HIC” and is used for evaluating the forces on the head of an individual as a result of an impact. Conventional processes used to determine the HIC include use of computer-aided engineering (CAE) simulations, which require significant processing power and time to carry out. However, when a new vehicle design is proposed, this process of using CAE simulations to determine the HIC of various portions of the vehicle is quite time-consuming thereby slowing down and increasing the cost of the design process.

### SUMMARY

In at least some implementations, a method of evaluating a vehicle body component design includes the steps of: calculating one or more head injury criteria (HIC) ground values for one or more points of interest of a base body component design of a base vehicle; generating an HIC predictive model based on the one or more HIC ground values; obtaining one or more parameter values of one or more points of interest of a candidate body component design, the one or more points of interest of the candidate body component design corresponding to the one or more points of interest of the base body component design of the base vehicle; calculating one or more predicted HIC values for the candidate body component design, wherein the calculation of the one or more predicted HIC values includes inputting the one or more parameter values into the HIC predictive model to obtain the one or more predicted HIC values; and evaluating the candidate body component design by inspecting the one or more predicted HIC values.

In at least some implementations, the one or more HIC ground values are obtained by carrying out a computer-aided engineering (CAE) simulation using the base body component design of the base vehicle. The one or more HIC ground values for the one or more points of interest of the base body component design may constitute a first set of HIC ground values, the base body component design of the base vehicle may constitute a first base body component design of a first base vehicle, and the calculating the one or more HIC ground values step may further include calculating a second set of HIC ground values for one or more points of interest of a second base body component design of a second base vehicle. The one or more points of interest of the first base body component design may correspond to the one or more points of interest of the second base body component design.

In at least some implementations, the one or more points of interest of the base body component design of the base vehicle is a plurality of points of interest of the base body component design of the base vehicle. The one or more points of interest of the candidate body component design may be a plurality of points of interest of the candidate body component design.

In at least some implementations, the HIC predictive model is generated using a T-method. The HIC predictive model may be represented at least in part by a linear equation and/or may be represented at least in part by a polynomial equation.

In at least some implementations, the HIC predictive model represents a relationship between dynamic stiffness and the one or more HIC ground values. The dynamic stiffness for the one or more points of interest of the base body component design may be determined by performing a noise, vibration, harshness (NVH) analysis using the base body component design. The relationship between the dynamic stiffness and the one or more HIC ground values may be determined by carrying out one or more correlation techniques to establish the correlation between the dynamic stiffness and the HIC ground values at each of the point(s) of interest.

In at least some implementations, for each of the point(s) of interest of the candidate body component design, at least one of the one or more parameter values is a measurement of a distance between the point of interest of the candidate body component design and another portion of a candidate vehicle on which the candidate body component design is to be used.

In at least some implementations, the base vehicle is selected based on the base vehicle being the same model as a candidate vehicle on which the candidate body component design is to be used. The base vehicle may be selected based on the base vehicle having the same body type as a candidate vehicle on which the candidate body component design is to be used.

In at least some implementations, the evaluating step includes comparing at least one of the predicted HIC value(s) to a first HIC threshold.

In at least some implementations, the method further comprises the step of obtaining one or more parameter values of the one or more points of interest of the base body component design, and the HIC predictive model is generated based on the one or more parameter values of the one or more points of interest of the base body component design.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a block diagram depicting an embodiment of a candidate design evaluation system that may be used to carry out one or more steps of a method of evaluating a vehicle body component design;

FIG. 2 is a flowchart of a method of evaluating a vehicle body component design;

FIG. 3 is a diagram depicting potential collisions that may occur between an object, such as a head of a pedestrian, and a body component of a vehicle; and

FIG. 4 is an overhead view of a front portion of a vehicle that corresponds to an area of the vehicle disposed below a hood of the vehicle and that illustrates various points of interest that may be selected for evaluation as a part of the method of FIG. 2.

### DETAILED DESCRIPTION

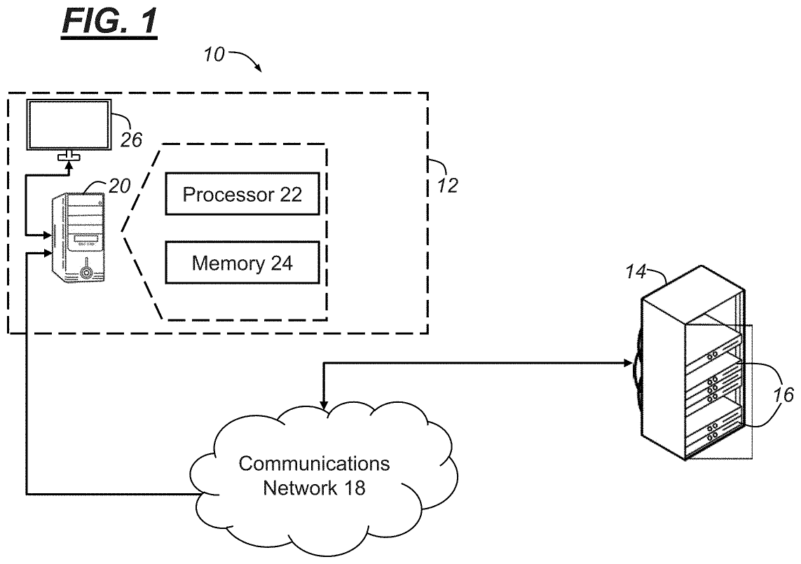

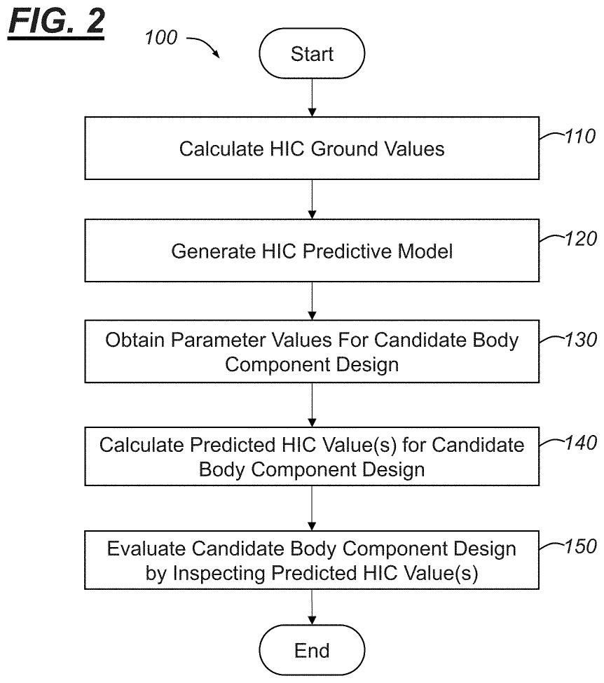

Referring in more detail to the drawings, FIG. 1 depicts a candidate design evaluation system 10 that may be used to carry out one or more steps of a method of evaluating a vehicle body component design, an embodiment of which is discussed below and shown in FIG. 2. The candidate design evaluation system 10 includes a computer workstation 12, a backend computer system 14 having one or more backend computers 16, and a communications network 18 that is used to interconnect the computer workstation 12 and the backend computer system 14. While the candidate design evaluation system 10 is shown in FIG. 1 as including only a single computer workstation 12 and a single backend computer system 14, it should be appreciated that, according to other embodiments, the candidate design evaluation system 10 includes a plurality of computer workstations and/or a plurality of backend computer systems.

The computer workstation 12 includes a computer 20, which may be any suitable electronic computer that includes a processor 22 that is configured to execute computer instructions that are stored on a non-transitory, computer-readable memory 24 accessible by the processor 22. The processor 22 may be any suitable electronic hardware that is capable of processing computer instructions, including central processing units (CPUs), graphics processing units (GPUs), field-programmable gate arrays (FPGAs), application specific integrated circuits (ASICs), microprocessors, microcontrollers, etc.

The memory 24 is capable of storing data or information in electronic form so that the stored data or information (referred to collectively herein as “stored data”) is consumable by the processor 22. The memory 24 may be any a variety of different electronic memory types, including magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc. It should be appreciated that the computer 20 may include other memory, such as volatile RAM that is used by the processor 22.

The computer workstation 12 also includes an electronic display 26, which is an example of a human-machine interface (HMI) and that is illustrated as a desktop computer monitor. The electronic display 26 is connected to the computer 20 and is used to present data or information from the computer 20 to an operator. The computer workstation 12 may include one or more other HMIs, such as one or more additional displays, a computer mouse, a keyboard, one or more speakers, etc., that enable the operator to communicate with the computer 20.

The backend computer system 14 is shown as a computer cabinet having the one or more backend computers 16, although this illustrates just one embodiment, and a variety of other setups and components may be used. The backend computer system 14 is connected to the computer 20 of the computer workstation 12 via the communications network 18. The one or more backend computers 16 each is a computer that includes a processor and a non-transitory, computer-readable memory that is accessible by the processor. The processor and memory may be any of those types discussed above with respect to the processor 22 and memory 24 of the computer 20 of the computer workstation 12. The one or more backend computers 16 may be used to store and/or manage data, such as for managing one or more databases. In one embodiment, the backend computer(s) 16 may be used to execute one or more computer programs or applications, such as for purposes of carrying out one or more steps or processes that are discussed below.

The communication network 18 is used to enable the computer 20 of the computer workstation 12 to communicate with the backend computer(s) 16 of the backed computer system 14, such as through sending packetized data using, for example, TCP/IP. The communication network 18 may be a local communication network or a remote communication network, and may be implemented using wired and/or wireless communication techniques.

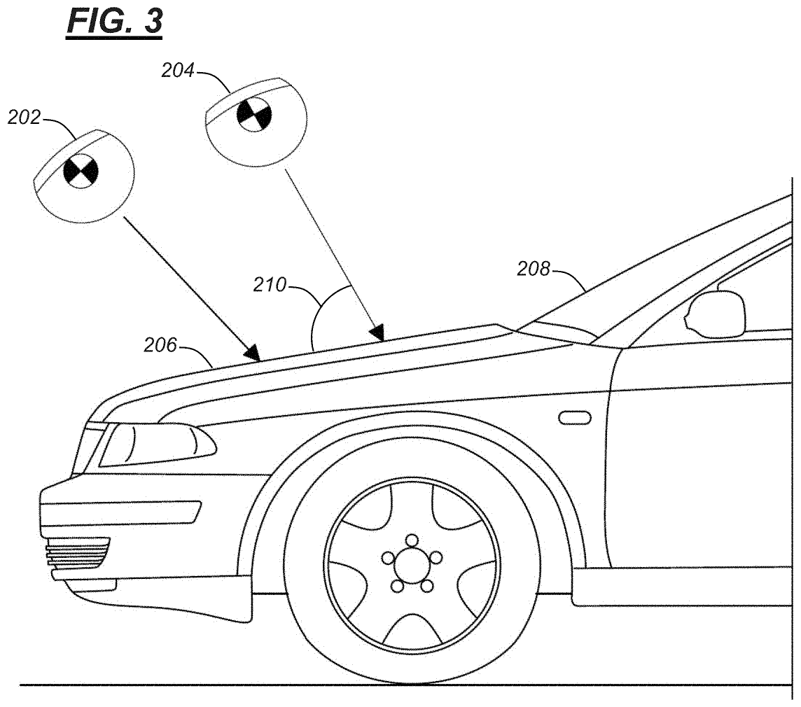

With reference to FIG. 2, there is shown an embodiment of a method 100 of evaluating a vehicle body component design. The method 100 is described below as being carried out by the candidate design evaluation system 10; however, in other embodiments, other suitable systems may be used to carry out the method 100. In one embodiment, the vehicle body component (or “body component” for short) is a hood of a vehicle. Collisions between the head of a pedestrian and the hood may be of particular interest and may be evaluated to assess the forces that the pedestrian may experience due to an impact. FIG. 3 provides a diagram depicting two potential collisions that may occur between the head 202, 204 of a pedestrian and the vehicle hood 206. An impact angle 210 is also illustrated as being the angle between a tangential plane of the hood 206 at the area of collision between the head 204 and the hood 206. The method 100 may be used to calculate predicted HIC value(s) for a potential or proposed design of a vehicle body component (referred to herein as a “candidate body component design”) and to then evaluate the candidate body component design based on those predicted HIC value(s).

As mentioned above, conventional processes used to evaluate the HIC include the use of CAE simulations, which are oftentimes quite time consuming. The method 100, at least according to some embodiments, enables an evaluation of a candidate body component design to be performed without having to carry out time- and resource-intensive CAE simulations for each candidate design and, in particular, for each point of interest of the candidate body component design for which an HIC value is desired. While the ultimate design that is selected for the body component may be evaluated using CAE simulations for purposes of verifying the HIC, the method 100 enables various candidate designs to be evaluated without having to use CAE simulations on each of those candidate designs, which results in reducing the amount of time, money and other resources spent during the design process.

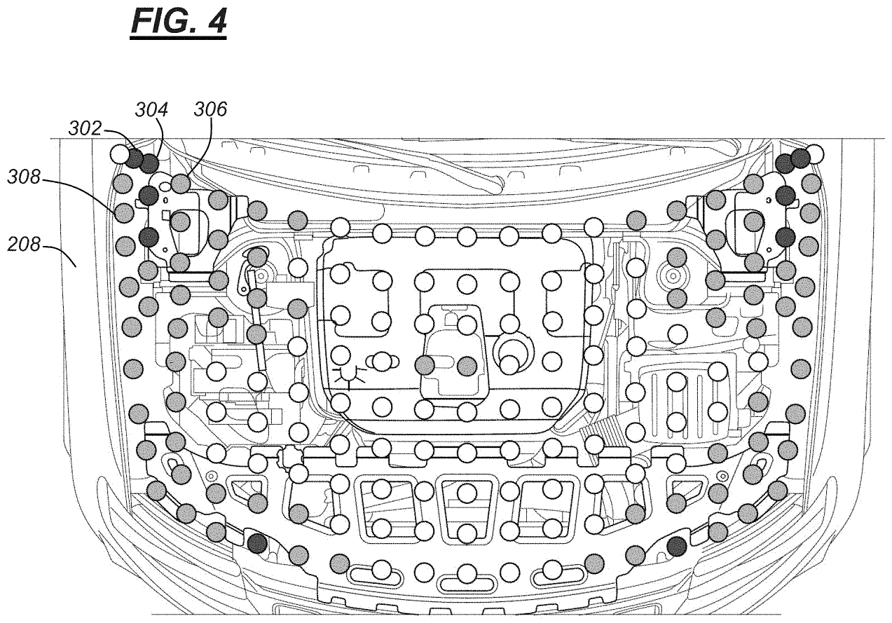

The method 100 of FIG. 2 begins with step 110, where one or more HIC ground values for one or more points of interest of a base body component design of a base vehicle are calculated. The base body component design refers to a design of a body component of the base vehicle. The one or more HIC ground values are each HIC values of a location or point of the base body component design. As used herein, an “HIC value” is the HIC at a particular location or point of an object, such as a particular point of a body component of a vehicle. The one or more points of interest are each a designated location or point of the body component and, in particular, may represent the location of the body component that is of particular interest when evaluating the body component (or a corresponding body component) with respect to pedestrian head impact. For example, as shown in FIG. 4, an overhead view of the vehicle 208 is shown with the hood 206 (FIG. 3) removed so that the components under the hood are visible. A plurality of potential points of interest are each illustrated as a circle. For purposes of illustration, the example of FIGS. 3 and 4 are occasionally referred to below when describing one potential application of the method 100, but it is to be understood that the method 100 may be applied to various different body components of a vehicle and even used in many other types of applications where it may be desirable to evaluate the HIC of systems that may collide with a head of an individual. Also, in some embodiments, the method may be used to calculate other metrics or values that relate to injury or impact, including those that do not necessarily relate to head injury or impact, instead of HIC values.

As will be discussed below, a candidate body component design is evaluated. The candidate body component design is a design of a body component that is to be used for a vehicle (referred to as the “candidate vehicle”) and that is different with respect to one or more design characteristics than those of the base body component design of the base vehicle. The body component that the candidate body component design is for corresponds to the body component that the base body component design is for. The body component of the candidate or base vehicle may be a component of a vehicle body, such as, for example, a hood, front or rear bumper, a door (e.g., a side door), a fender, a trunk, a side mirror, a roof, or a combination thereof. For example, the candidate body component design may be a design of a hood for a first vehicle model (e.g., a Cadillac CT4™) and the base body component design may be a design of a hood for a second vehicle model (e.g., a Cadillac CT5™). As another example, the base vehicle and the candidate vehicle are the same model (e.g., a Cadillac Escalade™), but the base body component design may be for a first model year and the candidate body component design may be for a different model year (e.g., a 2018 Cadillac Escalade as the base vehicle and a 2020 Cadillac Escalade™ as the candidate vehicle). And, as yet another example, the base vehicle and the candidate vehicle are the same model and model year, but the candidate body component design is a redesign of the base body component design.

According to some embodiments, the HIC ground values are HIC values that are to be used as a basis for setting values of certain variables of the HIC predictive model, which is then used to calculate predicted HIC values for the candidate base vehicle design. At least in some embodiments, the HIC ground values are generated by performing CAE simulations on one or more base body component designs. Each HIC ground value may be an HIC value that was calculated for a particular point of interest of the base body component design. So, in some embodiments, when a particular point of interest of the candidate body component design is to be evaluated, the HIC ground value that was calculated for a corresponding point of interest may be used to set certain variables of the HIC predictive model, which is then used to calculate the predicted HIC value for the particular point of interest. This methodology, which is described in more detail below, may be used to calculate a plurality of predicted HIC values for a plurality of points of interest, at least according to some embodiments. Thus, according to various embodiments, while the methodology may still use HIC values that were calculated using CAE simulations (the HIC ground values) to set certain variables of the HIC predictive model, new HIC ground values do not need to be calculated using the resource-intensive CAE simulations each time a new design is to be evaluated.

In some embodiments, multiple sets of one or more HIC ground values may be calculated, where each set of the one or more HIC ground values corresponds to a different one of a plurality of base body component designs. For example, a first set of one or more HIC ground values (referred to as a “first set of HIC ground values”) may be calculated for a first base body component design, which may be a body component design of a first base vehicle (e.g., a 2016 Cadillac Escalade™), and a second set of one or more HIC ground values (referred to as a “second set of HIC ground values”) may be calculated for a second base body component design, which may be a body component design of a second base vehicle (e.g., a 2018 Cadillac Escalade™). In one embodiment, each of the point(s) of interest of the HIC ground value(s) of the first set corresponds to a point of interest of one of the HIC ground value(s) of the second set. In other embodiments, one or more of the point(s) of interest of the first set of HIC ground values does not correspond to a point of interest of one of the HIC ground value(s) of the second set. Since the size, shape, and makeup of the various body component designs may vary with respect to one another, it should be appreciated that the process of identifying corresponding points of interest (e.g., a first point of interest of a first base vehicle and a corresponding point of interest of a second base vehicle or candidate vehicle) is not capable of being distilled down into a purely mechanical process and that those skilled in the art would appreciate the particularities to consider when identifying such corresponding points of interest. However, in general, a point of interest of a first body component design is considered to correspond to another point of interest of a second body component design when they are similarly located.

In at least one embodiment, the base vehicle(s) are selected based on their overall similarity to the candidate vehicle and, in particular, based on similarities between the base body component design and the candidate body component design. For example, in some embodiments of the method 100, multiple sets of the HIC ground value(s) may be calculated and stored, such as in memory 24 of the computer 20. Then, when a new candidate body component design is to be evaluated using the method 100, one or more sets of HIC ground value(s) may be selected, and this selection may take into consideration similarities between the candidate body component design and those base body component design(s) that the HIC ground value(s) were calculated for. Alternatively, or additionally, this selection may take into consideration similarities between a portion of the candidate vehicle on which the candidate vehicle design is to be used or installed and a corresponding portion of the base vehicle(s) on which the base body component design(s) are used or installed. For example, this selection could include selecting to use those HIC ground value(s) that were calculated for a base vehicle that is of the same model as the candidate vehicle. As another example, this selection could include selecting to use those HIC ground value(s) that were calculated for a base vehicle that has the same body style as the candidate vehicle. By selecting the HIC ground value(s) according to the above-noted similarities, a more accurate HIC predictive model is able to be generated when compared to one that is generated without taking into consideration such similarities.

The HIC ground value(s) may be calculated using various methodologies and, in one embodiment, are calculated using computer-aided engineering (CAE) simulations. As a part of this calculation, a computer-aided design (CAD) model may be developed, such as through use of the backend computer(s) 16 or the computer 20 of the computer workstation 12, for one or more portions of the base vehicle that include the base body component design. The CAD model may be developed using a CAD modeling tool, such as through use of ANSA offered by BETA CAE Systems™. As a part of developing the CAD model, one or more points of interest of the base body component design may be selected. For example, points of interest 302-308 (FIG. 4) may be selected as the points of interest of the base body component design. Additionally, in one embodiment, for each of the point(s) of interest, a headform is positioned and an impact angle and/or speed is selected. For example, as shown in FIG. 4, the points of interest 302-308 may be selected and, the impact angle, such as the impact angle 210 as shown in FIG. 3, may be specified for each of the points of interest during the CAE simulation. The positioning of the headform and selection of the impact angle and/or speed may be done through use of the ANSA Pedestrian Tool™, for example.

After the CAD model is developed, the CAD model is used as a part of a simulation so as to calculate the HIC ground value(s). In at least one embodiment, a finite element (FE) analysis may be performed on the CAD model through use of one or more computer simulation tools, such as through use of META™ post-processor offered by BETA CAE Systems™. As a result of the CAE simulation using the computer simulation tool(s), the one or more HIC ground values are obtained, which may be output by the computer simulation tool(s) as a table or spreadsheet with HIC values for the various points of interest. The method 100 then continues to step 120.

In step 120, an HIC predictive model is generated based on the one or more HIC ground values. In general, the HIC predictive model may be used to calculate a predicted HIC value for the candidate body component design for each of the one or more points of interest. While the HIC predictive model is referred to in the singular form, it should be appreciated that the HIC predictive model may include a plurality of models or equations for predicting HIC values at a plurality of points of interest. In many embodiments, the HIC predictive model is generated based on a plurality of HIC ground values for each of the points of interest. For example, the HIC ground values for a first point may be calculated through carrying out numerous CAE simulations and each of the HIC ground values may correspond to a sample value from one of those CAE simulations. The number of samples (or HIC ground values for a given point of interest) is denoted “n”.

In one embodiment, the T-method, which is a technique derived from the Taguchi Methods, is used to develop the HIC predictive model. The HIC predictive model may include an equation that is derived for each of the points of interest. The T-method, as applied here to generate the HIC predictive model, takes into consideration the HIC ground value(s) that were calculated in step 110, which are denoted “Mᵢ” (e.g., M₁, M₂, . . . Mₙ) below, where n is the number of samples. The T-method, as applied here to generate the HIC predictive model, also takes into consideration one or more input variables, which may each represent one or more design characteristics (or parameters) of the body component when installed as a part of the base vehicle. Examples of those variables are discussed below in step 130. For each of the input variables xₖ (where k is the index of the input variables), a signal-to-noise ratio nₖ and a sensitivity value βₖ are calculated. The sensitivity value βₖ represents the sensitivity between the input variable xₖ and the output value or HIC ground value.

The sensitivity value βₖ is calculated based on the HIC ground value(s) using the following equation:

$${β}_{k} = \frac{{M}_{1} {x}_{k , 1} + {M}_{2} {x}_{k , 2} + … + {M}_{n} {x}_{k , n}}{r} \qquad ( Equation 1 )$$

where Mᵢ represents the HIC ground value for sample i, x_{k,i} represents the value of the particular input variable k used as a part of the sample i, and r is calculated using the equation below:

r=M₁²+M₂²+ . . . +Mₙ² (Equation 2)

A signal-to-noise ratio nₖ is calculated for each of the input variables is calculated using the equations below:

$$\begin{matrix}{η}_{k} = \frac{{S}_{β , k} - {V}_{e , k}}{r ( {V}_{e , k} )} & ( Equation 3 ) \\ {S}_{β , k} = \frac{{( {M}_{1} {x}_{k , 1} + {M}_{2} {x}_{k , 2} + … + {M}_{n} {x}_{k , n} )}^{2}}{r} & ( Equation 4 ) \\ {V}_{e , k} = \frac{( {S}_{T , k} - {S}_{β , k} )}{n - 1} & ( Equation 5 ) \\ {S}_{T , k} = {{x}_{k , 1}}^{2} + {{x}_{k , 2}}^{2} + … + {{x}_{k , n}}^{2} & ( Equation 6 )\end{matrix}$$

Once the signal-to-noise ratios nₖ are determined for each of the input variables, a weighting factor wₖ for each of the signal-to-noise ratios nₖ may be determined by using the following equation:

$${w}_{k} = \frac{{η}_{k}}{{\sum }_{p = 1}^{p = K} {η}_{p}} \qquad ( Equation 7 )$$

where K represents the total number of input variables. According to one embodiment, the HIC predictive model is represented by:

$$HIC = Signal Avg . + {\sum }_{k = 1}^{k = K} \frac{{w}_{k} ( {x}_{k , input} - {x}_{k , avg} )}{{β}_{k}} \qquad ( Equation 8 )$$

where “Signal Avg.” represents the mean of the HIC ground values, x_{k,input} represents the value of the input variable k, and x_{k,avg} represents the average value of the input variable k of the n samples. In at least one embodiment, for each of the points of interest, different values for the “Signal Avg.,” weighting factor wₖ, the sensitivity value βₖ, and x_{k,avg} are calculated based on the HIC ground values that correspond to the point of interest. Then, those values that are for a particular point of interest may be used to calculate a predicted HIC value for a point of interest that corresponds to the particular point of interest. For example, the point of interest 306 (FIG. 4) may be used to calculate the HIC ground value(s) used in arriving at certain values used for Equation 8 above (e.g., “Signal Avg.,” wₖ, βₖ, x_{k,avg}), and, in such an example, this equation may use those values to calculate the predicted HIC value for a point of interest of the candidate body component design that corresponds to location or position to that point of interest 306. The calculations described above may be applied for purposes of calculating one or more additional predicted HIC values, each being for a different point of interest of the candidate body component design.

The HIC predictive model of Equation 8 above is but one example of an HIC predictive model that may be generated. It should be appreciated that other equations may be derived and used as the HIC predictive model. The HIC predictive model of Equation 8 is an example of a linear model. In other embodiments, a metamodel or polynomial model may be used and may be derived in a manner similar to Equation 8 above.

In another embodiment, instead of using an implementation of the T-method as described above, a point mobility simulation may be used to derive a relationship between the HIC ground values and dynamic stiffness, and this relationship may be captured by the HIC predictive model. This type of HIC predictive model that establishes a relationship between the dynamic stiffness and HIC ground values is referred to as a “dynamic stiffness HIC predictive model.” The point mobility simulation is carried out using computer programs that perform a noise, vibration, harshness (NVH) analysis, which is used to provide the dynamic stiffness at each of the point(s) of interest. In one embodiment, this NVH analysis may be performed using the computer 20 of the computer workstation 12 and/or the backend computer(s) 16. The relationship between the dynamic stiffness and the HIC ground values for each of the point(s) of interest may then be determined and used as a basis for the dynamic stiffness HIC predictive model. In one embodiment, one or more correlation techniques, such as a Pearson correlation technique, are carried out to establish the correlation between the dynamic stiffness and the HIC ground values at each of the point(s) of interest.

In at least some embodiments, the dynamic stiffness HIC predictive model establishes or captures a correlation between the HIC ground values and the dynamic stiffness for the base body component design. The dynamic stiffness for the candidate body component design may be calculated and then the dynamic stiffness HIC predictive model may be used to calculate a predicted HIC value using the dynamic stiffness for the candidate body component design. Since the dynamic stiffness HIC predictive model captures the correlation between the HIC ground values and the dynamic stiffness of the base body component design, which may be selected to be similar in nature to the candidate body component design, the dynamic stiffness HIC predictive model may use this correlation along with the dynamic stiffness of the candidate body component design to calculate accurate predicted HIC values. The method 100 then continues to step 130.

In step 130, obtaining one or more parameter values of one or more points of interest of a candidate body component design are obtained. As a part of this step, one or more points of interest of the candidate body component design are selected. Each of the one or more points of interest of the candidate body component design correspond to one of the point(s) of interest of the base body component design of the base vehicle. The point(s) of interest of the candidate body component design and those corresponding point(s) of interest of the base body component design are referred to as the “selected point(s) of interest.”

In many embodiments, at least one of the parameter value(s) is a continuous parameter value, which is a parameter value that may be measured as any real number, such as a distance or a force magnitude. And, in at least one embodiment, at least one of the parameter value(s) is a discrete parameter value, which is a parameter value that may be one of a finite number of possibilities, such as a count being represented only by integers or a value assigned to a particular category. In one embodiment, at least one parameter value is a measurement of a distance between the point of interest of the candidate body component and another portion of the candidate vehicle, which is an example of a continuous parameter value. For example, a first parameter value may represent a distance from the point of interest at an outer surface of the hood to another part of the candidate vehicle that is directly below the hood, such as an engine block, and a second parameter value may represent a distance from the point of interest at an inner surface of the hood to another part of the candidate vehicle that is directly below the hood. As another example, a third parameter value may represent a distance from the point of interest to a front latch of the hood. And, in some instances, one or more parameter values may be combined to create a new parameter value. For example, a fourth parameter value may be calculated as the difference between the first parameter value and the second parameter value.

In some embodiments, one or more of the parameter value(s) may represent one or more discrete characteristics of the candidate body component. In an example where the body component is a hood, the vehicle part that is disposed directly under the hood may be comprised of steel and, accordingly, may be assigned a parameter value of “2” whereas, when the vehicle part that is disposed directly under the hood is comprised of plastic, a value of “5” may be assigned to the parameter value. This is an example of a discrete parameter value.

In one embodiment, one or more of the parameter value(s) are obtained through use of a computer program, which may be executed on the computer 20 of the computer workstation 12. For example, a CAD model of the candidate vehicle, including the candidate body component, may be generated using one or more modeling tools or software. Then, the parameter value(s) may be obtained from this CAD model. For example, the first parameter value, which represents a distance from an outer surface of the vehicle hood to another part of the candidate vehicle directly below the vehicle hood, may be measured by applying computer-aided techniques to the CAD model. This measurement or process of determining the parameter value(s) may be carried out by an operator through use of computer tools, such as CAD software. However, alternatively or additionally, in one embodiment, a computer program may be developed so as to automatically determine one or more of the parameter value(s) based on the CAD model and without intervention from the operator.

In one embodiment, such as where the HIC predictive model is a dynamic stiffness HIC predictive model, this step may include determining the dynamic stiffness for each of the selected point(s) of interest of the candidate body component design. This step may thus include carrying out a point mobility simulation using computer programs that perform NVH analysis so as to obtain the dynamic stiffness at each of the selected point(s) of interest. The method 100 continues to step 140.

In step 140, one or more predicted HIC values for the candidate body component design are calculated. The calculation of the one or more predicted HIC values for the candidate body component design includes inputting the one or more parameter values into the HIC predictive model to obtain the one or more predicted HIC values. As mentioned above, in at least some embodiments, the predicted HIC values each relate to a particular point of interest and so those parameter value(s) for a particular point of interest are used to obtain a predicted HIC value for that point of interest. Accordingly, for each point of interest of a desired or selected set of points of interest, the HIC predictive model may be generated and applied using parameter value(s) that are particular to the selected point of interest. In one embodiment, such as where the HIC predictive model is based on the T-method, the parameter value(s) for a first point of interest obtained in step 130 may be input into Equation 8 as x_{k,input} to obtain the predicted HIC value for the first point of interest.

In one embodiment, the computer 20 of the computer workstation 12 may be configured so as to calculate a predicted HIC value for a particular point of interest in response to receiving input from a user representing parameter value(s) for that point of interest. In one example, a Microsoft Excel™ spreadsheet may be configured with the HIC predictive model. In such an example, an operator may insert data representing parameter value(s) for a particular point of interest into one or more cells of the spreadsheet and then, having been configured with the HIC predictive model, Microsoft Excel™ may then calculate a predicted HIC value for the particular point of interest. The method 100 then continues to step 150.

In step 150, the candidate body component design is evaluated by inspecting the one or more predicted HIC values. The evaluation may be performed by comparing each of the predicted HIC value(s) to an HIC threshold. For example, a first predicted HIC value, which corresponds to point of interest 302 (FIG. 4) and is a value of “1400”, is compared to the HIC threshold, which may be “1360”. In such an example, because the predicted HIC value (“1400”) exceeds the HIC threshold (“1360”), then it is determined that the candidate body component design needs to be redesigned at that portion where the point of interest 1302 resides. In some embodiments, multiple HIC thresholds are used to categorize each of the HIC predicted value(s). For example, a first HIC threshold may be “800” and a second HIC threshold may be “1360”.

In one embodiment, the point(s) of interest may be visually displayed over a graphic of a vehicle and then each point may be colored or shaded according to which category the corresponding predicted HIC value(s) falls into. These graphics may be displayed on the electronic display 26 of the computer workstation 12, for example. As shown in FIG. 4, the darker shaded circles indicate that the predicted HIC value for that point of interest is above the second HIC threshold, the medium shaded circles indicate that the predicted HIC value for that point of interest is above the first HIC threshold and below the second HIC threshold, and the white or non-shaded circles indicate that the predicted HIC value for that point of interest is below the first HIC threshold.

In one embodiment, based on the evaluation, it may be determined that one or more aspects of the candidate body component design are to be or should be redesigned. In such an embodiment, after having made any desired changes, the steps 130-150 may be carried out again on the redesigned candidate body component design. This iterative process may be carried out any desired number of iterations so as to continuously evaluate new designs of the candidate body component. The method 100 then ends.

What is claimed is:

1. A method of evaluating a vehicle body component design, comprising the steps of:
calculating one or more head injury criteria (HIC) ground values for one or more points of interest of a base body component design of a base vehicle;
generating an HIC predictive model based on the one or more HIC ground values;
obtaining one or more parameter values of one or more points of interest of a candidate body component design, the one or more points of interest of the candidate body component design corresponding to the one or more points of interest of the base body component design of the base vehicle;
calculating one or more predicted HIC values for the candidate body component design, wherein the calculation of the one or more predicted HIC values includes inputting the one or more parameter values into the HIC predictive model to obtain the one or more predicted HIC values; and
evaluating the candidate body component design by inspecting the one or more predicted HIC values.

2. The method of claim 1, wherein the one or more HIC ground values are obtained by carrying out a computer-aided engineering (CAE) simulation using the base body component design of the base vehicle.

3. The method of claim 1, wherein the one or more HIC ground values for the one or more points of interest of the base body component design constitute a first set of HIC ground values, wherein the base body component design of the base vehicle constitutes a first base body component design of a first base vehicle, and wherein the calculating the one or more HIC ground values step further includes calculating a second set of HIC ground values for one or more points of interest of a second base body component design of a second base vehicle.

4. The method of claim 3, wherein the one or more points of interest of the first base body component design correspond to the one or more points of interest of the second base body component design.

5. The method of claim 1, wherein the one or more points of interest of the base body component design of the base vehicle is a plurality of points of interest of the base body component design of the base vehicle.

6. The method of claim 5, wherein the one or more points of interest of the candidate body component design is a plurality of points of interest of the candidate body component design.

7. The method of claim 1, wherein the HIC predictive model is generated using a T-method.

8. The method of claim 7, wherein the HIC predictive model is represented at least in part by a linear equation.

9. The method of claim 7, wherein the HIC predictive model is represented at least in part by a polynomial equation.

10. The method of claim 1, wherein the HIC predictive model represents a relationship between dynamic stiffness and the one or more HIC ground values.

11. The method of claim 10, wherein the dynamic stiffness for the one or more points of interest of the base body component design is determined by performing a noise, vibration, harshness (NVH) analysis using the base body component design.

12. The method of claim 11, wherein the relationship between the dynamic stiffness and the one or more HIC ground values is determined by carrying out one or more correlation techniques to establish the correlation between the dynamic stiffness and the HIC ground values at each of the point(s) of interest.

13. The method of claim 1, wherein, for each of the point(s) of interest of the candidate body component design, at least one of the one or more parameter values is a measurement of a distance between the point of interest of the candidate body component design and another portion of a candidate vehicle on which the candidate body component design is to be used.

14. The method of claim 1, wherein the base vehicle is selected based on the base vehicle being the same model as a candidate vehicle on which the candidate body component design is to be used.

15. The method of claim 1, wherein the base vehicle is selected based on the base vehicle having the same body type as a candidate vehicle on which the candidate body component design is to be used.

16. The method of claim 1, wherein the evaluating step includes comparing at least one of the predicted HIC value(s) to a first HIC threshold.

17. The method of claim 1, wherein the method further comprises the step of obtaining one or more parameter values of the one or more points of interest of the base body component design, and wherein the HIC predictive model is generated based on the one or more parameter values of the one or more points of interest of the base body component design.
